(19) United States
(12) Patent Application Publication
(10) Pub. No.: US 2024/0428288 A1
(43) Pub. Date: Dec. 26, 2024

(54) DEVICE AND METHOD FOR SETTING PLURALITY OF USER ACCOUNTS TO SHARE DIGITAL COUPON

(71) Applicant: KAKAO CORP., Jeju-si (KR)

(72) Inventor: Eun Chan SHIN, Seongnam-si (KR)

(21) Appl. No.: 18/750,295

(22) Filed: Jun. 21, 2024

(30) Foreign Application Priority Data
Jun. 22, 2023 (KR) 10-2023-0080270

(51) Int. Cl. G06Q 30/0207

(52) U.S. Cl. CPC G06Q 30/0239

(57) ABSTRACT

A server includes a processor configured to, based on receiving a sharing request for a digital coupon, set a plurality of user accounts to share the digital coupon, and based on using at least a portion of the digital coupon, transmit a display command of a guidance message about a result of using the digital coupon to a plurality of user terminals corresponding to the plurality of user accounts.

### CROSS-REFERENCE TO RELATED APPLICATION

This application claims the benefit of Korean Patent Application No. 10-2023-0080270, filed on Jun. 22, 2023, in the Korean Intellectual Property Office, the entire disclosure of which is incorporated herein by reference for all purposes.

### BACKGROUND

### Technical Field

One or more embodiments relate to technology for setting a plurality of user accounts to share a digital coupon.

### Description of the Related Art

Recently, with the development of mobile smart devices, the use of an online platform service to communicate with other users via a network has increased. The online platform services for interaction with other users may include, as representative examples, a social networking service (SNS), which is an online platform for generating and consolidating social relationships through communication among users, information sharing, and expansion of personal connections, and an instant messaging service (IMS), which is an online platform for real-time content communication between two or more users. With the increase in communication through mobile devices, the online platform services support a function of giving and receiving gifts between users by incorporating e-commerce platforms, besides 1:1 communication with other users.

### BRIEF SUMMARY

According to an aspect, there is provided a digital coupon sharing method including, based on receiving a sharing request for a digital coupon, setting a plurality of user accounts to share the digital coupon and based on using at least a portion of the digital coupon, transmitting a display command of a guidance message about a result of using the digital coupon to a plurality of user terminals corresponding to the plurality of user accounts.

The setting of the plurality of user accounts to share the digital coupon may include receiving, from a user terminal corresponding to a user account that has purchased the digital coupon, a gift request for giving the digital coupon as a gift to the plurality of user accounts.

The digital coupon sharing method may further include, based on receiving an inquiry request for the digital coupon from a first user terminal corresponding to a first user account among the plurality of user accounts, transmitting a display command of information about the digital coupon to the first user terminal, based on using at least a portion of the digital coupon by a second user account among the plurality of user accounts, updating information about the digital coupon, and transmitting a display command of the updated information about the digital coupon to the first user terminal.

The setting of the plurality of user accounts to share the digital coupon may include setting a first user account designated as a primary user account by the sharing request as a primary user account, among the plurality of user accounts, and setting a second user account that is different from the first user account as a secondary user account, among the plurality of user accounts.

The setting of the plurality of user accounts to share the digital coupon may include receiving, from a user terminal corresponding to a user account that has purchased the digital coupon, a privilege setting request for setting a privilege for the digital coupon of a secondary user account among the plurality of user accounts.

The setting of the plurality of user accounts to share the digital coupon may include receiving, from a primary user terminal corresponding to a primary user account among the plurality of user accounts, a privilege setting request for setting a privilege for the digital coupon of a secondary user account among the plurality of user accounts.

The privilege for the digital coupon may include at least one of a period of sharing the digital coupon with the secondary user account, a portion of the digital coupon that is usable by the secondary user account, or a ratio to be refunded to the secondary user account when the digital coupon is refunded.

The setting of the plurality of user accounts to share the digital coupon may include generating a shared coupon box including at least one digital coupon shared by the plurality of user accounts, wherein the digital coupon sharing method may further include receiving a coupon addition request for adding another digital coupon to the shared coupon box and by adding the other digital coupon to the shared coupon box based on receiving the coupon addition request, setting the plurality of user accounts to share the other digital coupon.

According to another aspect, there is provided a server including a processor configured to, based on receiving a sharing request for a digital coupon, set a plurality of user accounts to share the digital coupon and based on using at least a portion of the digital coupon, transmit a display command of a guidance message about a result of using the digital coupon to a plurality of user terminals corresponding to the plurality of user accounts.

The processor may be further configured to receive, from a user terminal corresponding to a user account that has purchased the digital coupon, a gift request for giving the digital coupon as a gift to the plurality of user accounts.

The processor may be further configured to, based on receiving an inquiry request for the digital coupon from a first user terminal corresponding to a first user account among the plurality of user accounts, transmit a display command of information about the digital coupon to the first user terminal, based on using at least a portion of the digital coupon by a second user account among the plurality of user accounts, update information about the digital coupon, and transmit a display command of the updated information about the digital coupon to the first user terminal.

The processor may be further configured to set a first user account designated as a primary user account by the sharing request as a primary user account, among the plurality of user accounts, and set a second user account that is different from the first user account as a secondary user account, among the plurality of user accounts.

The processor may be further configured to receive, from a user terminal corresponding to a user account that has purchased the digital coupon, a privilege setting request for setting a privilege for the digital coupon of a secondary user account among the plurality of user accounts.

The processor may be further configured to receive, from a primary user terminal corresponding to a primary user account among the plurality of user accounts, a privilege setting request for setting a privilege for the digital coupon of a secondary user account among the plurality of user accounts.

The privilege for the digital coupon may include at least one of a period of sharing the digital coupon with the secondary user account, a portion of the digital coupon that is usable by the secondary user account, or a ratio to be refunded to the secondary user account when the digital coupon is refunded.

The processor may be further configured to generate a shared coupon box including at least one digital coupon shared by the plurality of user accounts, receive a coupon addition request for adding another digital coupon to the shared coupon box, and by adding the other digital coupon to the shared coupon box based on receiving the coupon addition request, set the plurality of user accounts to share the other digital coupon.

Additional aspects of embodiments will be set forth in part in the description which follows and, in part, will be apparent from the description, or may be learned by practice of the disclosure.

### BRIEF DESCRIPTION OF THE SEVERAL VIEWS OF THE DRAWINGS

These and/or other aspects, features, and advantages of the disclosure will become apparent and more readily appreciated from the following description of embodiments, taken in conjunction with the accompanying drawings of which:

FIG. 1 is a diagram illustrating a digital coupon system according to various embodiments;

FIG. 2 is a diagram illustrating an example of an operation of a digital coupon system, according to various embodiments;

FIG. 3 is a flowchart illustrating an example of a digital coupon sharing method of a server, according to various embodiments;

FIG. 4A is a system diagram illustrating an example of an operation of setting a plurality of user accounts to share a digital coupon based on a gift request, according to various embodiments;

FIG. 4B is a diagram illustrating an example of an interface for setting a plurality of user accounts to share a digital coupon based on a gift request, according to various embodiments; and

FIG. 5 is a flowchart illustrating an example of an operation of adding a digital coupon to a shared gift box of a digital coupon system, according to various embodiments.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

The term “and/or” as used herein is intended to cover all possible combinations of the options mentioned. In particular, the text “and/or” is used to indicate that one or both of the options it connects are possible. For example, “A and/or B” means: (1) A alone, (2) B alone, (3) Both A and B together.

It should be noted that if one component is described as being “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like components and a repeated description related thereto will be omitted.

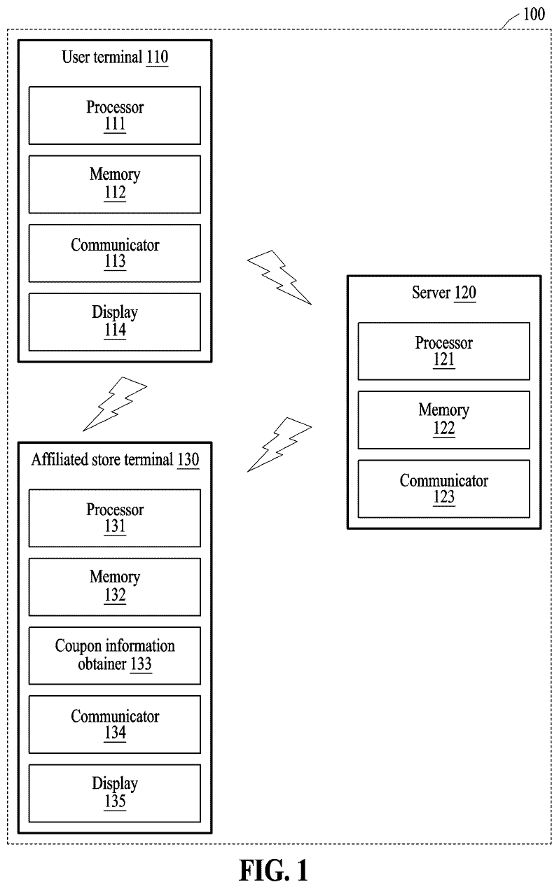

FIG. 1 is a diagram illustrating a digital coupon system according to various embodiments.

A digital coupon system 100 according to an embodiment may include a user terminal 110, a server 120, and an affiliated store terminal 130.

The user terminal 110 may refer to one of electronic devices, such as a computer, a portable computer, a wireless phone, a mobile phone, a smartphone, a personalized digital assistant (PDA), a web tablet, and any device that includes a display and that may install and execute a service application related to the server 120. Here, the user terminal 110 may perform overall service operations such as service screen configuration, data input, data transmission and reception, and data storage under control by the application. For example, the user terminal 110 may access the server 120 through the application. For example, the user terminal 110 may use an instant messaging service (IMS) provided by the server 120.

The server 120 may provide a service to the user terminal 110 and/or the affiliated store terminal 130. For example, the server 120 may provide an IMS or a social networking service (SNS). The server 120 may provide a digital coupon service (e.g., a gift service). According to an embodiment, the server 120 may include an instant messaging server (not shown) and a digital coupon server (not shown). The instant messaging server may provide an IMS to the user terminal 110. The digital coupon server may provide the digital coupon service to the user terminal 110 and/or the affiliated store terminal 130. The digital coupon service may provide the user terminal 110 with purchase, delivery (e.g., a gift), sharing, and/or refund of a digital coupon and may support transactions of products (or services) through the digital coupon to the user terminal 110 and the affiliated store terminal 130.

A digital coupon is used to prove that a user has a privilege to the goods indicated by the digital coupon and may, for example, include a digital voucher and/or a digital certificate. According to an embodiment, a digital coupon may be purchased by one user account and delivered to another user account. For example, a digital coupon may be offered as a gift from one user account to another user account. The other user account that has received the digital coupon as a gift may consume the goods indicated by the digital coupon by presenting the digital coupon (or information about the digital coupon).

Types of digital coupon may include, for example, product exchange vouchers and value vouchers. A product exchange voucher may indicate a digital coupon in which the whole digital coupon is used at once as there is a product (or service) corresponding to the goods indicated by the digital coupon and the product (or service) has indivisible properties. A value voucher may indicate a digital coupon that may be used at once or in installments as there is an asset corresponding to the goods indicated by the digital coupon and the asset has divisible properties.

A user account is generated when a user signs up for a service provided by the server 120, and the server 120 may serve as a service platform that provides a service to a user account registered for a service such as an SNS, an IMS, and the like. A user account described herein mainly refers to an account registered for an IMS. Since the user terminal 110 may use a service using a user account, a user account included in the following embodiments may be construed as corresponding to the user terminal 110.

The affiliated store terminal 130 may refer to one of electronic devices, such as a computer, a portable computer, a wireless phone, a mobile phone, a smartphone, a PDA, a web tablet, and any device that includes a display and that may install and execute a service application related to the server 120. Here, the affiliated store terminal 130 may perform overall service operations such as service screen configuration, data input, data transmission and reception, and data storage under control by the application. For example, the affiliated store terminal 130 may access the server 120 through the application. For example, the affiliated store terminal 130 may use a digital coupon service provided by the server 120.

According to an embodiment, the user terminal 110 may include a processor 111, a memory 112, a communicator 113, and a display 114.

The processor 111 transmits, to the server 120, a sharing request for a plurality of user accounts to share a digital coupon. The processor 111 receives, from the server 120, a display command of a guidance message about a result of using the digital coupon. The processor 111 may display the guidance message about a result of using the digital coupon based on using at least some of the digital coupon. The processor 111 may temporarily or permanently store, in the memory 112, data required for transmitting the sharing request, receiving the display command of the guidance message, and/or displaying the guidance message. According to an embodiment, the processor 111 may comprise at least one processing circuitry.

The memory 112 may store information about the sharing request, the display command of the guidance message, and/or the guidance message. The memory 112 may store instructions for transmitting the sharing request, receiving the display command, and/or displaying the guidance message.

The communicator 113 may transmit at least one of the sharing request or the display command. The communicator 113 may establish a wired communication channel and/or a wireless communication channel with an external device (e.g., another electronic device and a server), and may establish communication, for example, via cellular communication, short-range wireless communication, local area network (LAN) communication, Bluetooth, wireless-fidelity (Wi-Fi) direct, or infrared data association (IrDA), or via a long-range communication network such as a legacy cellular network, a fourth generation (4G) and/or fifth generation (5G) network, next-generation communication, the Internet, or a computer network (e.g., a LAN or a wide area network (WAN)). According to an embodiment, the communicator 113 may comprise at least one communication circuitry.

The display 114 may display information about the digital coupon. The display 114 may be, for example, a touch display in which a touch sensing module and a display module are integrally implemented.

According to an embodiment, the server 120 may include a processor 121, a memory 122, and a communicator 123.

The processor 121 may receive the sharing request from the user terminal 110. The processor 121 may set the plurality of user accounts to share the digital coupon. The processor 121 may transmit the display command of the guidance message to a plurality of user terminals based on using at least some of the digital coupon. The processor 121 may temporarily or permanently store, in the memory 122, data required for receiving the sharing request, setting the digital coupon, and/or transmitting the display command of the guidance message. According to an embodiment, the processor 121 may comprise at least one processing circuitry.

The memory 122 may store information about the sharing request, the digital coupon, and/or the display command. The memory 122 may store instructions for receiving the sharing request, setting the digital coupon, and/or transmitting the display command of the guidance message.

The communicator 123 may transmit at least one of the sharing request, information about the digital coupon, or the guidance message. The communicator 123 may establish a wired communication channel and/or a wireless communication channel with an external device (e.g., the user terminal 110 and another electronic device), and may establish communication, for example, via cellular communication, short-range wireless communication, LAN communication, Bluetooth, Wi-Fi direct, or IrDA, or via a long-range communication network such as a legacy cellular network, a 4G and/or 5G network, next-generation communication, the Internet, or a computer network (e.g., a LAN or a WAN). According to an embodiment, the communicator 123 may comprise at least one communication circuitry.

According to an embodiment, the affiliated store terminal 130 may include a processor 131, a memory 132, a coupon information obtainer 133, a communicator 134, and a display 135.

The processor 131 may obtain information about the digital coupon displayed by the user terminal 110. The processor 131 may transmit a usage request for at least some of the digital coupon to the server 120. The processor 131 may receive a usage result for the at least some of the digital coupon from the server 120. The processor 131 may temporarily or permanently store, in the memory 132, data required for obtaining information about the digital coupon, transmitting the usage request, and/or receiving the usage result. According to an embodiment, the processor 131 may comprise at least one processing circuitry.

The memory 132 may store the information about the digital coupon, the usage request, and/or the usage result. The memory 132 may store instructions for obtaining the information about the digital coupon, transmitting the usage request, and/or receiving the usage result.

The coupon information obtainer 133 may obtain the information about the digital coupon. According to an embodiment, the user terminal 110 may display the information about the digital coupon (e.g., a barcode and a quick-response (QR) code), and the coupon information obtainer 133 may be implemented as a camera and may obtain the information about the digital coupon by scanning the information about the displayed information about the digital coupon. According to an embodiment, the user terminal 110 may transmit the information about the digital coupon to the affiliated store terminal 130. The coupon information obtainer 133 of the affiliated store terminal 130 may be integrally implemented with the communicator 134 and may obtain the information about the digital coupon from the user terminal 110.

The communicator 134 may transmit at least one of information about the digital coupon, the usage request, or the usage result. The communicator 134 may establish a wired communication channel and/or a wireless communication channel with an external device (e.g., another electronic device and a server), and may establish communication, for example, via cellular communication, short-range wireless communication, LAN communication, Bluetooth, Wi-Fi direct, or IrDA, or via a long-range communication network such as a legacy cellular network, a 4G and/or 5G network, next-generation communication, the Internet, or a computer network (e.g., a LAN or a WAN). According to an embodiment, the communicator 134 may comprise at least one communication circuitry.

The display 135 may display the information about the digital coupon, the usage request, or the usage result. The display 135 may be, for example, a touch display in which a touch sensing module and a display module are integrally implemented.

In the present disclosure, the usage request for the digital coupon is mainly described as being transmitted from the affiliated store terminal 130 to the server 120 but is not limited thereto. For example, the usage request for the digital coupon may be transmitted from the user terminal 110 to the server 120. The server 120 may transmit the usage result of the digital coupon to the user terminal 110 and/or the affiliated store terminal 130 based on the usage request for the digital coupon received from the user terminal 110.

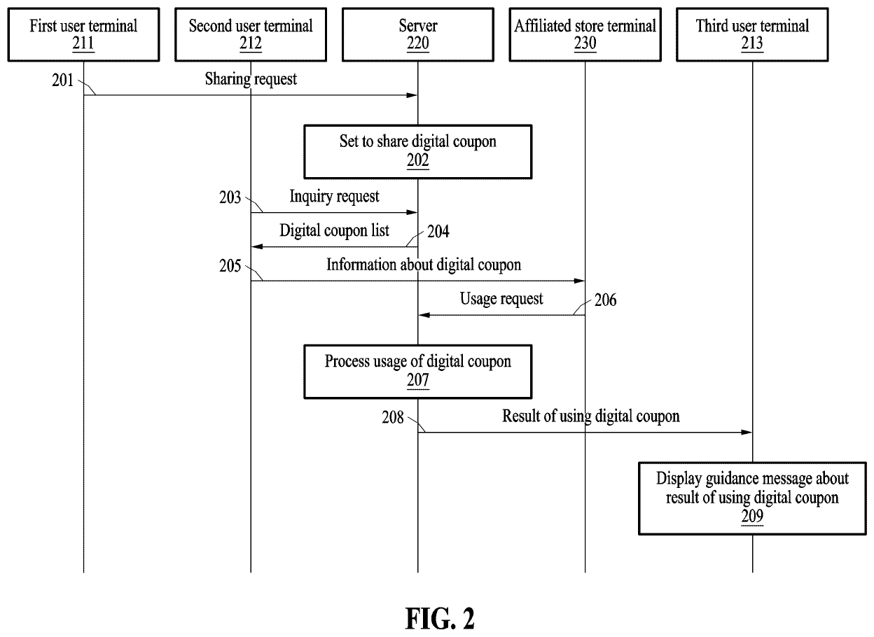

FIG. 2 is a diagram illustrating an example of an operation of a digital coupon system, according to various embodiments.

According to an embodiment, a digital coupon system (e.g., the digital coupon system 100 of FIG. 1) may include a first user terminal 211 (e.g., the user terminal 110 of FIG. 1), a second user terminal 212 (e.g., the user terminal 110 of FIG. 1), a server 220 (e.g., the server 120 of FIG. 1), and an affiliated store terminal 230 (e.g., the affiliated store terminal 230 of FIG. 1). The first user terminal 211 may correspond to a first user account and the second user terminal 212 may correspond to a second user account. For example, the first user terminal 211 may access a service provided by the server 220 through the first user account, the second user terminal 212 may access a service provided by the server 220 through the second user account, and the third user terminal 213 may access a service provided by the server 220 through a third user account.

In operation 201, the first user terminal 211 may transmit a sharing request for a digital coupon to the server 220. The server 220 may receive the sharing request for the digital coupon from the first user terminal 211. The sharing request may refer to a request for a plurality of user accounts to share the digital coupon. According to an embodiment, the sharing request may designate a plurality of user accounts as a subject of sharing and the digital coupon as an object of sharing. In FIG. 2, for example, the sharing request may be a sharing request about giving the digital coupon purchased by the first user account to a second user account and a third user account as a gift. The sharing request may designate the second user account and the third user account as the subject of sharing and may designate the digital coupon as the object of sharing.

In operation 202, the server 220 may set a plurality of user accounts to share the digital coupon, based on receiving the sharing request for the digital coupon from the first user terminal 211. The server 220 may set the subject of sharing designated by the sharing request to share the object of sharing designated by the sharing request. For example, the server 220 may set the second user account and the third user account to share the digital coupon. In the present disclosure, “the sharing of a digital coupon by a plurality of user accounts” may refer to each of the plurality of user accounts having at least some rights (e.g., inquiry rights, usage rights, refund rights, and sharing rights) for the digital coupon.

In operation 203, the second user terminal 212 may transmit an inquiry request for the digital coupon list of the second user account to the server 220. The server 220 receives, from the second user terminal 212, the inquiry request for the digital coupon list of the second user account.

In operation 204, the server 220 may transmit the digital coupon list including the information about the digital coupon to the second user terminal 212. For example, when the second user account shares the digital coupon with another user account (e.g., the third user account), the digital coupon list of the second user account may include information about the digital coupon shared by the other user account (e.g., the third user account).

In operation 205, the second user terminal 212 may transmit the information about the digital coupon to the affiliated store terminal 230. The affiliated store terminal 230 may obtain the information about the digital coupon from the second user terminal 212. As described above with reference to FIG. 1, the second user terminal 212 may display the information about the digital coupon and the affiliated store terminal 230 may scan the information about the displayed digital coupon, or the information about the digital coupon may be transmitted from the second user terminal 212 to the affiliated store terminal 230.

In operation 206, the affiliated store terminal 230 may transmit a usage request for the digital coupon to the server 220. The server 220 may receive the usage request of the digital coupon from the affiliated store terminal 230. The usage request may include a request to use at least some of the digital coupon. According to an embodiment, the usage request may designate at least some of the digital coupon as an object of use and/or may designate a user account corresponding to a user terminal displaying the digital coupon as a subject of use.

In operation 207, the server 220 may process the usage of the digital coupon based on the usage request. For example, the server 220 may change the information about the digital coupon based on the usage request and may transmit a result of using the digital coupon to the second user terminal 212 and/or the affiliated store terminal 230.

In operation 208, the server 220 may transmit the result of using the digital coupon to the third user terminal 213 that shares the digital coupon with the second user terminal (or the second user account). The third user terminal 213 may receive the result of using the digital coupon from the server 220.

In operation 209, the third user terminal 213 may display a guidance message about the result of using the digital coupon. When the digital coupon shared by the second user account and the third user account is used by the second user account, information about the usage of the digital coupon is transmitted to the third user account, thereby providing updated information about the digital coupon to the third user account.

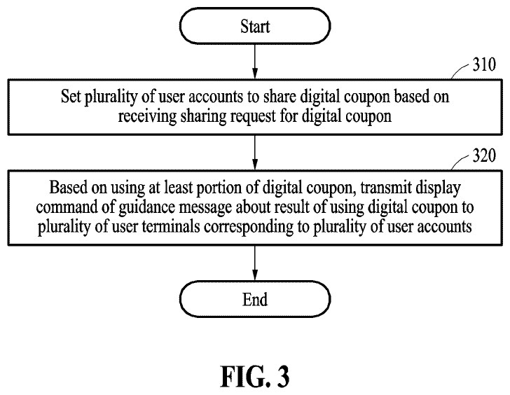

FIG. 3 is a flowchart illustrating an example of a digital coupon sharing method of a server, according to various embodiments.

According to an embodiment, a digital coupon system (e.g., the digital coupon system 100 of FIG. 1) may include a user terminal (e.g., the user terminal 110 of FIG. 1, the first user terminal 211 of FIG. 2, and the second user terminal 212 of FIG. 2) and a server (the server 120 of FIG. 1 and the server 220 of FIG. 2).

In operation 310, the server may set a plurality of user accounts to share a digital coupon based on receiving a sharing request for the digital coupon. The sharing request may include information about at least one of the digital coupons designated as an object of sharing or at least one user account designated as a subject of sharing. The server may allow a plurality of user accounts designated as the subject of sharing in the sharing request to use the digital coupon designated as the object of sharing in the sharing request. The server may set usage a privilege for the digital coupon for each of the plurality of user accounts.

According to an embodiment, the server may receive, from a user terminal corresponding to a user account (in the present disclosure, also expressed as a “gift purchaser account”) that has purchased the digital coupon, a gift request for giving the digital coupon as a gift to the plurality of user accounts. The server may set the plurality of user accounts designated by the gift request to share the digital coupon.

The gift request may refer to a request for delivering the digital coupon purchased by the gift purchaser account to a gift receiver account. The gift request may include the digital coupon designated as an object of a gift and the gift receiver account designated as a receiver of a gift. When the gift receiver account is designated as the plurality of user accounts in the gift request, the gift request may refer to a sharing request for designating the object of a gift designated by the gift request as an object of sharing and designating the receiver of a gift designated by the gift request as a subject of sharing.

The server may set a primary user account and a secondary user account among the plurality of user accounts that share the digital coupon. The sharing request may designate the primary user account among the plurality of user accounts designated as the subject of sharing. A user account that is different from the user account designated as the primary user account may be designated as the secondary user account. For example, the server may set, among the plurality of user accounts, a first user account designated as the primary user account by the sharing request as the primary user account. The server may set second user accounts that are different from the first user account, among the plurality of user accounts, as secondary user accounts.

For example, when the server receives the gift request for giving a digital coupon as a gift to the plurality of user accounts from the user terminal corresponding to the gift purchaser account, at least one user account among the plurality of user accounts may be designated as the primary user account by the gift request. The primary user account designated in the gift request may be determined based on an input from a gift purchaser. Based on the gift request, the server may set the primary user account and the secondary user account among the plurality of user accounts that share the digital coupon.

The primary user account may set a privilege for the digital coupon of the secondary user accounts that share the digital coupon. A primary user terminal corresponding to the primary user account may transmit, to the server, a privilege configuration request for setting the privilege for the digital coupon for the secondary user account. The server may receive the privilege configuration request for setting the privilege for the digital coupon of the secondary user account from a primary user terminal corresponding to the primary user account. The server may set the privilege for the digital coupon of the secondary user account based on the privilege configuration request.

The privilege for the digital coupon may include a request for setting a privilege for at least one of a period of sharing the digital coupon with the secondary user account, a portion of the digital coupon that is usable by the secondary user account, or a ratio to be refunded to the secondary user account when the digital coupon is refunded.

The period of sharing the digital coupon may include at least one of whether the period of sharing is extended in accordance with an extension of an expiration date of the digital coupon or the number of times the period of sharing is extended in accordance with the extension of the expiration date of the digital coupon. For example, when the period of sharing the digital coupon is set to be extended in accordance with the extension of the expiration date of the digital coupon, the server may extend the period of sharing in accordance with the extension of the expiration date of the digital coupon. For example, when the period of sharing the digital coupon is set to be extended up to two times in accordance with the extension of the expiration date of the digital coupon, the server may extend the period of sharing in accordance with a first extension of the expiration date and a second extension of the expiration date of the digital coupon, may not extend the period of sharing in accordance with a third extension of the expiration date of the digital coupon, and may set to stop sharing the digital coupon with the secondary user accounts.

In operation 320, based on using at least some of the digital coupon, the server may transmit information about a result of using the digital coupon to a plurality of user terminals corresponding to the plurality of user accounts. For example, the information about a result of using the digital coupon may comprise a display command of a guidance message. For example, the information about a result of using the digital coupon information about the digital coupon that is updated after at least some of the digital coupon is used.

The information about the digital coupon may include at least one of information required to use the digital coupon (e.g. a barcode, a QR code, and a serial number), information about a gift purchaser account of the digital coupon, information about whether the digital coupon has been used, a portion of a usable digital coupon (e.g., a balance), a usage history of the digital coupon (e.g., usage time, usage location, information about the user account that has used the digital coupon, a portion of the digital coupon used (e.g., a usage amount)), or information about other user accounts that share the digital coupon.

According to an embodiment, the server may receive a usage request for the digital coupon from an affiliated store terminal (or a user terminal). The server may transmit the result of using the digital coupon to the affiliated store terminal and the user terminal based on the usage request. The server may transmit the display command of the guidance message about a result of using the digital coupon to the plurality of user terminals based on sharing the digital coupon by the plurality of user accounts.

Although not explicitly shown in FIG. 3, the server may transmit, to the user terminal, the display command of a digital coupon list including information about the digital coupon shared by the plurality of user accounts, based on receiving an inquiry request for the digital coupon list of one user account from one of the plurality of user accounts. For example, the server may transmit, to the first user terminal, the digital coupon list including the information about the digital coupon shared by the plurality of user accounts. The server may transmit, to the second user terminal, the digital coupon list including the information about the digital coupon shared by the plurality of user accounts. The information about the digital coupon shared by the plurality of user accounts may be displayed by the plurality of user terminals corresponding to the plurality of user accounts.

The digital coupon list of a user account may include information about at least one digital coupon owned by the user account. The digital coupon list of the user account may include information about a digital coupon solely owned by the user account and information about a digital coupon that the user account shares with other user accounts.

According to an embodiment, when the digital coupon is used by one user account among the plurality of user accounts, the server may provide updated information about the digital coupon to other user accounts. For example, the server may receive the inquiry request for the digital coupon from the first user terminal corresponding to the first user account among the plurality of user accounts. The server may transmit the display command of the information about the digital coupon to the first user terminal. The first user terminal may display the information about the digital coupon. The server may update the information about the digital coupon, based on using at least some of the digital coupon by the second user account among the plurality of user accounts. The server may transmit the display command of the updated information about the digital coupon to the first user terminal. The first user terminal may display the updated information about the digital coupon.

According to an embodiment, even when the digital coupon is used by one user account among the plurality of user accounts that share the digital coupon, the server may synchronize and provide information whether the digital coupon may be used and/or a usable portion of the digital coupon, among the plurality of user accounts, by transmitting a guidance message about the usage result to the other user account or by inquiring for the information about the digital coupon in which the usage result is reflected through the other user account. On the contrary, according to a comparative embodiment, even if the plurality of user accounts shares the digital coupon, when one user account uses the digital coupon and when a guidance message for the usage result is not transmitted to other user accounts or information about the digital coupon inquired by the other user accounts is not updated, the other user accounts have difficulty obtaining the information for the one user account using the digital coupon, and thus, the other user accounts may have difficulty knowing whether the shared digital coupon is available and/or how much of the digital coupons is available.

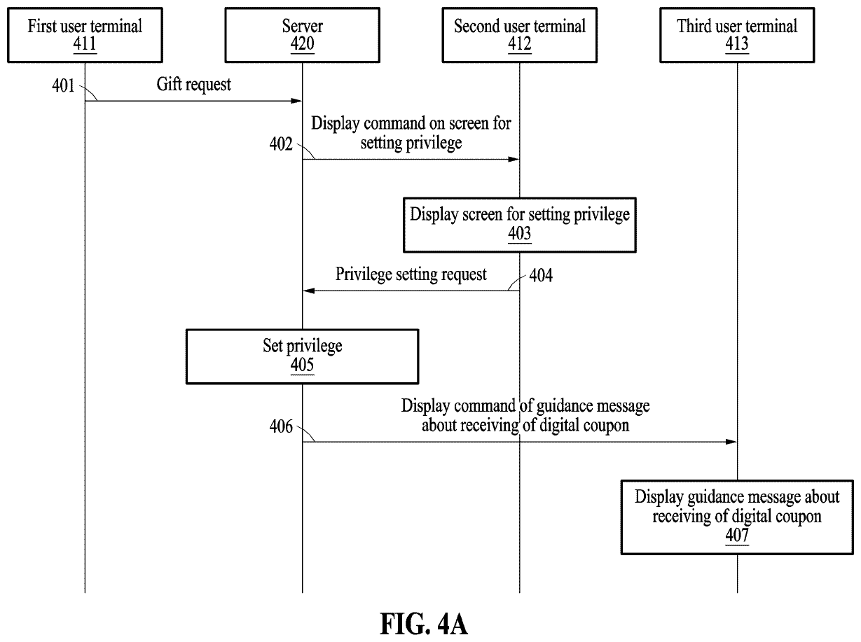

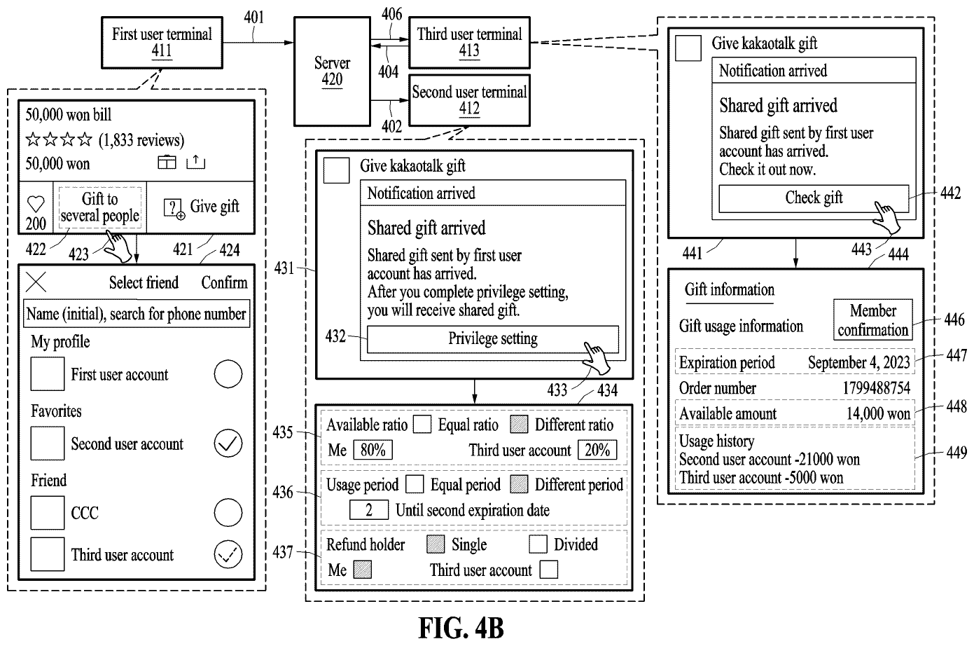

FIG. 4A is a system diagram illustrating an example of an operation of setting a plurality of user accounts to share a digital coupon based on a gift request, according to various embodiments. FIG. 4B is a diagram illustrating an example of an interface for setting a plurality of user accounts to share a digital coupon based on a gift request, according to various embodiments.

A digital coupon system (e.g., the digital coupon system 100 of FIG. 1) according to an embodiment may include a first user terminal 411 (e.g., the user terminal 110 of FIG. 1), a second user terminal 412 (e.g., the user terminal 110 of FIG. 1), a third user terminal 413 (e.g., the user terminal 110 of FIG. 1), and a server 420 (e.g., the server 120 of FIG. 1 and the server 220 of FIG. 2).

For example, the first user terminal 411 may access a service provided by the server 420 through the first user account, the second user terminal 412 may access a service provided by the server 420 through the second user account, and the third user terminal 413 may access a service provided by the server 420 through the third user account. For example, in FIGS. 4A and 4B, the first user account may gift a digital coupon to the second user account and the third user account.

In operation 401, the first user terminal 411 may transmit a gift request to the server 420. The server 420 may receive the gift request from the first user terminal 411. The gift request may designate the second user account and the third user account as receivers of the gift, may designate the second user account as a primary user account and may designate the digital coupon as an object of the gift.

For example, as shown in FIG. 4B, the first user terminal 411 may display, on a screen 421, an area 422 related to giving gifts to a plurality of user accounts. The first user terminal 411 may display a screen 424 for designating the plurality of user accounts based on detecting a user input 423 in the area 422. The first user terminal 411 may designate the plurality of user accounts as receivers of the gift based on the user input 423 and may select a primary user account from among the plurality of user accounts. According to an embodiment, the first user terminal 411 may designate a user account that is first designated as the receiver of the gift as the primary user account and may designate other user accounts designated as the receiver of the gift as secondary user accounts. According to an embodiment, as shown in the screen 424, the first user terminal 411 may display a selection of the second user account designated as the primary user account in a first graphical representation (e.g., a solid line), and may display a selection of the third user account designated as the secondary user account in a second graphical representation (e.g., a dashed line).

In operation 402, the server 420 transmits, to the second user terminal 412, a display command on a screen for setting a privilege of the secondary user account. The second user terminal 412 receives, from the server 420, the display command on a screen for setting the privilege of the secondary user account.

In operation 403, the second user terminal 412 may display a screen for setting the privilege of the secondary user account. The second user terminal 412 may display a screen for setting the privilege for the third user account, which is a secondary user account. For example, as shown in FIG. 4B, the second user terminal 412 may include a screen 431 that displays a guidance message for receiving the digital coupon shared with the third user account and setting the privilege, based on the gift request. The screen 431 may include an area 432 for calling a screen for setting the privilege. The second user terminal 412 may display a screen 434 for setting the privilege based on detecting a user input 433 in the area 432 of the screen 431. The screen 434 may include an area 435 for setting a portion usable by the secondary user account, an area 436 for setting a period of sharing the digital coupon with the secondary user account, and an area 437 for setting a ratio to be refunded to the secondary user account when the digital coupon is refunded.

In operation 404, the second user terminal 412 transmits, to the server 420, a privilege setting request for setting the privilege of the third user account, which is a secondary user account. The server 420 may receive the privilege setting request from the second user terminal 412. The second user terminal 412 may generate the privilege setting request based on a user input detected for a screen for setting the privilege and may transmit the privilege setting request to the server 420.

Although it is mainly described with reference to FIGS. 4A and 4B that the privilege of a secondary user account is set by a primary user account, embodiments are not limited thereto. The privilege for the digital coupon of the secondary user account may be set by a user account that purchased the digital coupon.

For example, the server 420 transmits, to the first user terminal 411, a display command on a screen for setting the privilege of the secondary user account. The first user terminal 411 receives, from the server 420, the display command on a screen for setting the privilege of the secondary user account. The first user terminal 411 may display a screen for setting the privilege for the secondary user account (e.g., the third user account). The first user terminal 411 transmits, to the server 420, the privilege setting request for setting the privilege of the secondary user account (e.g., the third user account).

In operation 405, the server 420 may set the privilege for the digital coupon of the third user account, based on the privilege setting request.

In operation 406, the server 420 transmits, to the third user terminal 413, a display command of a guidance message about receiving of the digital coupon. The third user terminal 413 may receive the display command of the guidance message about the receiving of the digital coupon.

In operation 407, the third user terminal 413 may display the guidance message about the receiving of the digital coupon. For example, as shown in FIG. 4B, the third user terminal 413 may display a screen 441 including the guidance message about the receiving of the digital coupon. The screen 441 may include an area 442 for inquiring for the received digital coupon.

The third user terminal 413 may transmit an inquiry request for the digital coupon to the server 420, based on detecting a user input 443 in the area 442. The server 420 transmits, to the third user terminal 413, a display command on a screen 444 including information about the digital coupon, based on receiving the inquiry request from the third user terminal 413. The third user terminal 413 may display the screen 444. The screen 444 may include an area 446 for an inquiry request for the user accounts sharing the digital coupon. The screen 444 may include an area 447 corresponding to an expiration date of the digital coupon, an area 448 corresponding to an available amount of the digital coupon, and an area 449 corresponding to a usage history of the digital coupon.

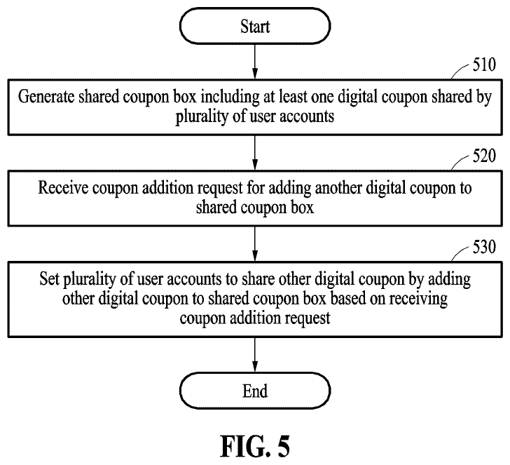

FIG. 5 is a flowchart illustrating an example of adding a digital coupon to a shared gift box of a digital coupon system, according to various embodiments.

A digital coupon system (e.g., the digital coupon system 100 of FIG. 1) according to an embodiment may include a first user terminal (e.g., the user terminal 110 of FIG. 1), a second user terminal (e.g., the user terminal 110 of FIG. 1), and a server (e.g., the server 120 of FIG. 1 and the server 220 of FIG. 2).

In operation 510, the server may generate a shared coupon box including at least one digital coupon shared by a plurality of user accounts. The shared coupon box of the plurality of user accounts may include the at least one digital coupon shared by the plurality of user accounts. For example, when the server sets the plurality of user accounts to share the digital coupon, the server may generate the shared coupon box corresponding to the plurality of user accounts and may add the digital coupon to the shared coupon box.

In operation 520, the server may receive a coupon addition request for adding another digital coupon to the shared coupon box.

According to an embodiment, when the server receives a sharing request for the plurality of user accounts to share a second digital coupon while the plurality of user accounts is sharing a first digital coupon, the server may treat the sharing request as a coupon addition request for adding the second digital coupon to the shared coupon box of the plurality of user accounts. When the server receives a sharing request for the plurality of user accounts to share a digital coupon while there is no digital coupon shared by the plurality of user accounts, the server may treat the sharing request as a shared coupon box generation request and a coupon addition request. For example, the server may generate the shared coupon box based on the sharing request and may add a digital coupon to the generated shared coupon box.

According to an embodiment, the digital coupon shared by the plurality of user accounts may include a digital coupon that has already been used. Even when a first digital coupon shared by the plurality of user accounts is completely used, the shared coupon box of the plurality of user accounts may be maintained without being deleted. Thereafter, when the plurality of user accounts receives a sharing request for sharing a second digital coupon, the server may skip generating of the shared coupon box, based on the first digital coupon. The server may set the shared coupon box to include the second digital coupon together with the first digital coupon that has been used.

According to an embodiment, the digital coupon shared by the plurality of user accounts may exclude (e.g., may not include) the digital coupon that has already been used. When the first digital coupon shared by the plurality of user accounts has been used, the server may delete the first digital coupon from the shared coupon box of the plurality of user accounts. The server may delete the shared coupon box of the plurality of user accounts when all digital coupon(s) shared by the plurality of user accounts have been used. Thereafter, when the plurality of user accounts receives the sharing request for sharing the second digital coupon, the server may re-generate the shared coupon box. The server may restrict the shared coupon box from including the first digital coupon that has been used and may set the shared coupon box to include the second digital coupon.

For example, the server may receive a coupon addition request for giving another digital coupon as a gift purchased by another user account to the plurality of user accounts, from a user terminal corresponding to the other user account that is different from the plurality of user accounts.

In operation 530, the server may set the plurality of user accounts to share the other digital coupon by adding the other digital coupon to the shared coupon box based on receiving the coupon addition request.

According to an embodiment, the server may transmit a display command on a screen for setting a privilege of a secondary user account among the plurality of user accounts, to a primary user terminal corresponding to a primary user account for the other digital coupon among the plurality of user accounts. The server may receive a privilege setting request for the secondary user account about the other digital coupon from the primary user terminal of the other digital coupon. The server may set the privilege of the secondary user account for the other digital coupon, based on the privilege setting request of the secondary user account.

With respect to the digital coupons included in the same shared coupon box, the primary user account and the secondary user account may be designated independently (e.g., differently) for each of the digital coupons. For example, the primary user account of the first digital coupon included in the shared coupon box may be designated as a first user account and the secondary user account of the first digital coupon may be designated as a second user account. On the other hand, the primary user account of the second digital coupon included in the shared coupon box may be designated as the second user account, and the secondary user account of the second digital coupon may be designated as the first user account.

With respect to the digital coupons included in the same shared coupon box, the privilege of the secondary user account for the digital coupons may be designated independently (e.g., differently) to each of the digital coupons. For example, for the first digital coupon included in the shared coupon box, the first user account may be set as having a refund privilege and for the second digital coupon included in the shared coupon box, the first user account may not be set as having the refund privilege.

In FIG. 5, the shared coupon box is mainly described as being identified according to a subject of sharing (e.g., the plurality of user accounts), and the primary user account and the secondary user account are designated for each digital coupon included in the shared coupon box. However, embodiments are not limited thereto. The shared coupon box may be identified based on a subject of sharing, a primary user account, a secondary user account, and a privilege of the secondary user account, and the primary user account, the secondary user account, the privilege of the secondary user account for the digital coupons included in the shared box may be the same.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described devices may be configured to act as one or more software modules in order to perform the operations of the above-described embodiments, or vice versa.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

A number of embodiments have been described above. Nevertheless, it should be understood that various modifications may be made to these embodiments. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

The invention claimed is:

1. A digital coupon sharing method, performed by a server, comprising:
based on receiving a sharing request for a digital coupon, setting a plurality of user accounts to share the digital coupon; and
based on using at least a portion of the digital coupon, transmitting information about a result of using the digital coupon to a plurality of user terminals corresponding to the plurality of user accounts.

2. The digital coupon sharing method of claim 1, wherein the setting of the plurality of user accounts to share the digital coupon comprises:
receiving, from a user terminal corresponding to a user account that has purchased the digital coupon, a gift request for giving the digital coupon as a gift to the plurality of user accounts.

3. The digital coupon sharing method of claim 1, further comprising:
based on receiving an inquiry request for the digital coupon from a first user terminal corresponding to a first user account among the plurality of user accounts, transmitting a display command of information about the digital coupon to the first user terminal;
based on using at least a portion of the digital coupon by a second user account among the plurality of user accounts, updating information about the digital coupon; and
transmitting a display command of the updated information about the digital coupon to the first user terminal.

4. The digital coupon sharing method of claim 1, wherein
the setting of the plurality of user accounts to share the digital coupon comprises:
setting a first user account as a primary user account based on a designation by the sharing request, among the plurality of user accounts; and
setting a second user account that is different from the first user account as a secondary user account, among the plurality of user accounts.

5. The digital coupon sharing method of claim 1, wherein
the setting of the plurality of user accounts to share the digital coupon comprises receiving, from a user terminal corresponding to a user account that has purchased the digital coupon, a privilege setting request for setting a privilege for the digital coupon of a secondary user account among the plurality of user accounts.

6. The digital coupon sharing method of claim 1, wherein
the setting of the plurality of user accounts to share the digital coupon comprises receiving, from a primary user terminal corresponding to a primary user account among the plurality of user accounts, a privilege setting request for setting a privilege for the digital coupon of a secondary user account among the plurality of user accounts.

7. The digital coupon sharing method of claim 6, wherein
the privilege for the digital coupon comprises at least one of a period of sharing the digital coupon with the secondary user account, a portion of the digital coupon that is usable by the secondary user account, or a ratio to be refunded to the secondary user account when the digital coupon is refunded.

8. The digital coupon sharing method of claim 1, wherein
the setting of the plurality of user accounts to share the digital coupon comprises generating a shared coupon box including at least one digital coupon shared by the plurality of user accounts,
wherein the digital coupon sharing method further comprises:
receiving a coupon addition request for adding another digital coupon to the shared coupon box; and
by adding the other digital coupon to the shared coupon box based on receiving the coupon addition request, setting the plurality of user accounts to share the other digital coupon.

9. A non-transitory computer-readable storage medium storing instructions that, when executed by one or more processors, cause the one or more processors to perform a method, the method comprising:
based on receiving a sharing request for a digital coupon, setting a plurality of user accounts to share the digital coupon; and
based on using at least a portion of the digital coupon, transmitting information about a result of using the digital coupon to a plurality of user terminals corresponding to the plurality of user accounts.

10. A server comprising:
at least one processor;
memory configured to store instructions,
wherein the instructions, when executed by the at least one processor, cause the server to:
based on receiving a sharing request for a digital coupon, set a plurality of user accounts to share the digital coupon; and
based on using at least a portion of the digital coupon, transmit information about a result of using the digital coupon to a plurality of user terminals corresponding to the plurality of user accounts.

11. The server of claim 10, wherein the instructions, when executed by the at least on processor, cause the server to:
receive, from a user terminal corresponding to a user account that has purchased the digital coupon, a gift request for giving the digital coupon as a gift to the plurality of user accounts.

12. The server of claim 10, wherein the instructions, when executed by the at least on processor, cause the server to:
based on receiving an inquiry request for the digital coupon from a first user terminal corresponding to a first user account among the plurality of user accounts, transmit a display command of information about the digital coupon to the first user terminal;
based on using at least a portion of the digital coupon by a second user account among the plurality of user accounts, update information about the digital coupon; and
transmit a display command of the updated information about the digital coupon to the first user terminal.

13. The server of claim 10, wherein the instructions, when executed by the at least on processor, cause the server to:
set a first user account as a primary user account, which is designated by the sharing request as a primary user account, among the plurality of user accounts; and
set a second user account that is different from the first user account as a secondary user account, among the plurality of user accounts.

14. The server of claim 10, wherein the instructions, when executed by the at least on processor, cause the server to:
receive, from a user terminal corresponding to a user account that has purchased the digital coupon, a privilege setting request for setting a privilege for the digital coupon of a secondary user account among the plurality of user accounts.

15. The server of claim 10, wherein the instructions, when executed by the at least on processor, cause the server to:
receive, from a primary user terminal corresponding to a primary user account among the plurality of user accounts, a privilege setting request for setting a privilege for the digital coupon of a secondary user account among the plurality of user accounts.

16. The server of claim 15, wherein
the privilege for the digital coupon comprises at least one of a period of sharing the digital coupon with the secondary user account, a portion of the digital coupon that is usable by the secondary user account, or a ratio to be refunded to the secondary user account when the digital coupon is refunded.

17. The server of claim 10, wherein the instructions, when executed by the at least one processor, cause the server to:
generate a shared coupon box including at least one digital coupon shared by the plurality of user accounts;
receive a coupon addition request for adding another digital coupon to the shared coupon box; and
by adding the other digital coupon to the shared coupon box based on receiving the coupon addition request, set the plurality of user accounts to share the other digital coupon.
